(19) United States
(12) Patent Application Publication
(10) Pub. No.: US 2026/0082306 A1
(43) Pub. Date: Mar. 19, 2026

(54) Methods and Systems for County Code Based Call Routing

(71) Applicant: T-Mobile Innovations LLC, Overland Park, KS (US)

(72) Inventors: Jeanna GREEN, Lee’s Summit, MO (US); Teresa KASPROWICZ, Snoqualmie, WA (US); Patrick O’GALLAGHER, Bangor, PA (US); Dennis ROMERO, Celina, TX (US); Adriano SANTOS, Ocean, NJ (US)

(21) Appl. No.: 18/888,081

(22) Filed: Sep. 17, 2024

(51) Int. Cl. H04W 40/20; H04W 4/16

(52) U.S. Cl. CPC H04W 40/20; H04W 4/16

(57) ABSTRACT

A gateway mobile location center configured to obtain a county location code identifying a county in which a user equipment (UE) is located using a location data store based on a call received from the UE, a border gateway control function configured to translate a call code received from the gateway mobile location center into a routing code using a translation data store, in which the translation data store indicates a destination number corresponding to a predefined short code associated with at least one of the call code or the routing code, and a session border controller configured to transmit, to a provider system, a message carrying the destination number and the county location code, in which the county location code is carried in a caller identification field of the message.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The 988 short code is a three-digit dialing code designated in the United States for the National Suicide Prevention Lifeline. It was established to provide an easy-to-remember and quick access number for individuals experiencing a mental health crisis or suicidal thoughts to reach crisis counselors and receive immediate help. When a user device dials 988, the call is routed to a crisis center within the network. The caller is connected to a trained crisis counselor who provides immediate support and assesses the situation. The counselor can offer crisis intervention, de-escalation techniques, and referrals to additional mental health services. From a network standpoint, providing the 988 service involves several key steps to ensure that calls are correctly routed and handled efficiently.

### SUMMARY

In an embodiment, a method implemented in a communication network to perform call routing to a call center based on a county associated with a location of a user is disclosed. The method comprises receiving, by a cell site associated with a core network system, a call from a user equipment (UE) associated with the user, in which the call is initiated by the UE dialing a predefined short code, and transmitting, by the cell site, the call with data identifying the UE and indicating a location of the UE to a gateway mobile location center of the core network system. The method further comprises obtaining, by the gateway mobile location center of the core network system, a county location code from a location data store mapping the location of the UE with the county location code, adding, by the gateway mobile location center, a call code to a second message, in which the call code comprises a plurality of steering digits and the county location code, and sending, by the gateway mobile location center, the second message to a border gateway control function of the core network system. The method further comprises identifying, by the border gateway control function, a toll-free provider system to route the call based on a mapping between the call code and the toll-free provider system indicated in a routing data store, translating, by the border gateway control function, the call code into a routing code using a translation data store, in which the translation data store indicates a destination number corresponding to the predefined short code, and transmitting, by the border gateway control function, a third message comprising the routing code and an identification of the toll-free provider system to a session border controller of the core network system. The method further comprises generating, by the session border controller, a fourth message comprising a header carrying the destination number and the county location code, and transmitting, by the session border controller, the fourth message to the toll-free provider system to route the call to a call center based on the county location code.

In another embodiment, a method implemented in a communication network to perform call routing to a call center based on a county associated with a location of a user is disclosed. The method comprises obtaining, by a gateway mobile location center of a core network system, a county location code identifying a county in which a UE associated with the user is located using a location data store based on a call received from the UE, and sending, by the gateway mobile location center, a first session initiation protocol invite to a border gateway control function of the core network system, in which the first session initiation protocol invite comprises a call code including a plurality of steering digits and the county location code. The method further comprises identifying, by the border gateway control function, a provider system based on a mapping between the call code and a provider system indicated in a routing data store, translating, by the border gateway control function, the call code into a routing code using a translation data store, in which the translation data store indicates a destination number corresponding to a predefined short code dialed by the UE, and transmitting, by the border gateway control function, a second session initiation protocol invite comprising the routing code and an identification of the provider system to a session border controller of the core network system. The method further comprises generating, by the session border controller, a third session initiation protocol invite carrying the destination number and the county location code, in which the county location code is carried in a field of the third session initiation protocol, and transmitting, by the session border controller, the third session initiation protocol invite to the provider system to route the call to a call center based on the county location code.

In yet another embodiment, a core network system is disclosed. The core network system comprises at least one processor, at least one memory coupled to the processor, a gateway mobile location center, stored in the at least one memory, which when executed by the at least one processor, causes the gateway mobile location center to obtain a county location code identifying a county in which a user equipment (UE) associated with a user is located using a location data store based on a call received from the UE, a border gateway control function, stored in the at least one memory, which when executed by the at least one processor, causes the border gateway control function to translate a call code received from the gateway mobile location center into a routing code using a translation data store, in which the translation data store indicates a destination number corresponding to a predefined short code associated with at least one of the call code or the routing code, and a session border controller, stored in the at least one memory, which when executed by the at least one processor, causes the session border controller to transmit, to a provider system, a message carrying the destination number and the county location code, in which the county location code is carried in a caller identification field of the message.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network for county code-based call routing according to various embodiments of the disclosure.

FIG. 2 is a block diagram illustrating a method for county code-based call routing in the communication network of FIG. 1 according to various embodiments of the disclosure.

FIG. 3 is a diagram illustrating an example of a message exchanged in the method of FIG. 2 according to various embodiments of the disclosure.

FIG. 4 is a flowchart of a first method for county code-based call routing in the communication network of FIG. 1 according to various embodiments of the disclosure.

FIG. 5 is a flowchart of a second method for county code-based call routing in the communication network of FIG. 1 according to various embodiments of the disclosure.

FIG. 6 is a block diagram of a computer system implemented within the communication network of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Various abbreviated telephone numbers (also referred to as short codes) are reserved in the nation as easy-to-remember three-digit codes to reach information and referral services to health, human, and social service organizations. For example, 988 is one such short code designated for the National Suicide Prevention Lifeline, which as described above connects a caller to a counselor in a crisis center. The short codes may also be associated with a full 11-digit 800 number, and the network may translate short codes entered by users into the full 800 number in the back end to route the call to the end destination. In many cases, the calls are routed to the end destination (e.g., the crisis center when the caller is dialing the 988 short code) based on the area code of the device calling the short code. For example, when a user dials 988 at a user equipment (UE), the call is routed to a crisis center within the network based on the area code of the UE.

However, the routing of the short code call from the UE based on the area code of the UE is technically problematic for various reasons. For example, an individual may purchase a UE (e.g., mobile phone) in a region in which the individual resides. The UE may be provided a mobile number with a particular area code based on the region where the user resides. The individual may later move to another region or another state and keep the same UE with the same mobile number (e.g., since the mobile number is already known by others as being associated with the individual), even though the individual no longer resides within the region. This is a common occurrence amongst individuals with mobile phones that later move to different states or regions within the nation. Therefore, the area code in a phone number of a UE is often not indicative of the actual location of the UE.

When the user operates the UE to call the short code from a new region or state that is not associated with the area code (e.g., a certain distance away from the region that is associated with the area code), the call may still be routed through the network to a crisis center based on the area code of the UE. Said another way, the call may be routed to a much farther crisis center because the network assumes that the UE and thus the user are still located in the region associated with the area code. Therefore, the short code-based call may often be routed across long distances based on the area code of the UE rather than the actual location of the UE, thereby wasting network resources and reducing the network capacity.

Meanwhile, the precise location of the UE may sometimes need to be kept private based on the service provided by the crisis centers. For example, users may call the National Suicide Prevention Lifeline to have an anonymous discussion with a counselor, and thus the user may dial the 988 short code corresponding to the National Suicide Prevention Lifeline with the expectation that the location of the user may not easily be tracked. Therefore, the network may have to identify an accurate current location of the UE (i.e., not based on the area code) to connect the caller to the best crisis center, and the network may have to obfuscate the actual location of the UE (to protect the privacy of the user), but to a reasonable extent. For example, mapping the location of the UE to a wide area, such as a major trading area (MTA), may be suboptimal because there may be many crisis centers within an MTA. Meanwhile, using the actual longitude and latitude coordinates of the user may violate the privacy of the caller because the coordinates may be passed through the network in the process of connecting the caller to the crisis center. Therefore, there is a need for privacy-enabled location-based routing of calls to services provided by the network.

The present disclosure addresses the foregoing technical problems by providing a technical solution in the technical field of location identification and call routing, particularly in the field of 800/short code-based calls. In various embodiments, a core network system configured to provide the backbone network services for the 800/short code calls may be enhanced to associate each incoming call with a county location code. The county location code may be a unique code assigned to each county (and county equivalent) in the nation, or may be another unique code assigned to a particular geographic area. A county is a predefined administrative division of a state (e.g., there are over 3,000 counties in the nation, and each county may be assigned a unique county location code). The county location code may be based on, for example, a federal information processing standard (FIPs) code that is preregistered for each county by a federal organization. The core network system may provide the county location code in a manner as further discussed herein to a toll-free provider system, which then forwards the call to a call routing system, which ultimately transmits the call to the optimal call center based on the county location code. Since the county location code is based on the actual location (e.g., county) of the calling UE, the call routing system may ensure that the call is routed to the optimal (e.g., closest) call center to the calling UE, thereby conserving network resources and increasing network capacity. In addition, the use of the county location code instead of the actual location of the UE (e.g., instead of the latitude/longitude coordinates of the UE) protects the privacy of the caller by preventing the actual location of the caller from passing through the network and being shared with the toll-free provider system and the call routing system.

In some embodiments, the core network system is operated by a telecommunications service providing company. The core network system may include a radio access network (RAN), which includes multiple cell sites that may serve different coverage areas and the UEs within the coverage areas based on a location of a respective UE. The core network system may include a Gateway Mobile Location Center (GMLC), a Border Gateway Control Function (BGCF), a Session Border Controller (SBC), and one or more applications. In an embodiment, the GMLC, BGCF, and SBC may each be applications running across one or more computer systems of the core network system, and each of the GMLC, BGCF, and SBC may have secure access to various data stores stored across various memories of the core network system.

For example, the core network system may include a location data store, a routing data store, and a translation data store. The location data store may include mappings between a location of the UE and a corresponding county location code. The location of the UE may be based on various types of location data, such as, for example, latitude and longitude coordinates of the UE (e.g., received from the UE), a known location of the cell site serving the UE, a registered location of the user operating the UE, etc. The routing data store may include call codes generated for the calls that may be received from the UEs. A call code may be an ordered sequence of numerical digits, including multiple predefined steering digits and the county location code. The location data store may store a mapping between each call code and an identification of a corresponding toll-free provider system (e.g., which provides a free communications channel through a public switched telephone network (PSTN) to a call routing system (e.g., a third-party system that routes the calls to an appropriate call center)). The translation data store may include mappings between the call code and a routing code. The routing code may also be an ordered sequence of numerical digits, including the county location code and a destination number corresponding to a dialed short code.

In an embodiment, a user may operate a UE to dial a short code corresponding to a particular service (e.g., the 988 short code) to be connected with a specialized counselor at a nearby calling center. A cell site serving the UE may receive the call and obtain an identification of the UE (e.g., Mobile Station International Subscriber Directory Number (MSISDN), International Mobile Subscriber Identity (IMSI), etc.). The cell site may forward the call to the core network system. An application (e.g., a Call Session Control Function (CSCF) or a Telephony Application Server (TAS)) at the core network system may further process the call to identify the location of the UE and forward the call (e.g., in the form of a Session Initiation Protocol (SIP) invite) to another entity in the core network system. The application may identify a location of the UE based on various factors. In one case, the location of the UE may be identified based on location information carried in the call (e.g., in the Presence Information Data Format Location Object (PIDF-LO) of the Session Initiation Protocol (SIP) invite corresponding to the call). This location information may be an actual location of the UE, or actual latitude and longitude coordinates of the UE. The application may identify the location of the UE as the location of the cell site from which the call was received. The application may identify the location of the UE based on a registered address of the UE (e.g., corresponding to a subscription of the user) or a location estimate obtained using a mobile terminal-location request procedure. The application may also determine that the call is to be routed to a call center based on the location of the UE, and thus the call is to be routed to the GMLC. The application may then transmit a first message (e.g., in the form of a SIP invite) including the identification of the UE and the location of the UE to the GMLC.

The GMLC may then access the location data store to identify a county location code associated with the location of the UE. As mentioned above, the county location code may be a predefined set of numeric digits uniquely identifying each county in the nation. For example, the county location code may be a five-digit code. In an embodiment, the location data store may include a mapping of the actual location of the UE (e.g., the latitude and longitude coordinates of the UE) to the county location code corresponding to the location of the UE. In addition or alternatively, the location data store may include a mapping of the location of the cell site to the county location code corresponding to the location of the UE.

The GMLC may then programmatically obtain (e.g., generate or determine) a call code based on the identified county location code using rules and/or logic programmed at the GMLC. The call code may include multiple steering digits (e.g., predefined or placeholder) and the county location code. For example, the call code may include the following digits: 99801 (e.g., the steering digits)+the five-digit county location code. In an embodiment, the steering digits may correspond to a full 11-digit 800 phone number.

The GMLC may then transmit a second message (e.g., in the form of a SIP invite) including the call code to the BGCF. The BGCF may then access the routing data store to obtain an identification of a corresponding toll-free provider system to route the call based on a mapping between at least a portion of the call code and the toll-free provider system included in the routing data store.

The BGCF may also access the translation data store, obtain a routing code corresponding to at least a portion of the call code based on a destination number and code translation rules stored at the translation table. The destination number may be the full 11-digit 800 phone number corresponding to the steering digits in the call code. The code translation rules may include rules and/or logic instructing the BGCF to translate the call code into the routing code using the destination number (e.g., by prepending the call code with predefined digits, removing the steering digits, and appending call code with the destination number, to obtain the routing code). For example, the routing code may include predefined digits prepended to the county location code and a destination number, which may be obtained from the translation data store based on the call code. For example, when the call code is 99801 (e.g., the steering digits)+the five digit county location code, the corresponding routing code may be 111 (e.g., predefined digits)+the five digit county location code+the 800 destination number.

The BCF may transmit a third message (e.g., in the form of a SIP invite) comprising the routing code and the identification of the toll-free provider system to the SBC. The SBC may modify the prepended county location code in the routing code by removing at least two of the predefined digits to obtain a routing number (e.g., 1+five digit county location code). The SBC may then generate a fourth message (e.g., in the form of a SIP invite), in which the destination number is added to one field in a header (or body) of the fourth message, and the routing number (with the county location code) is added to another field in the header (or body) of the fourth message. For example, the destination number may be added to a request uniform resource identifier (RURI) field of the fourth message, and the routing number may be appended to an existing field of the fourth message or added into a new dedicated field of the fourth message.

The SBC may then route the fourth message (including the routing number and the destination number) to the identified toll-free provider system. The toll-free provider system may generate and transmit the call via the PSTN to a call routing system (which may be a third-party vendor or an internal system). The call routing system may identify an optimal call center to route the call from the UE based on the county location code included in the routing number received from the SBC/toll-free provider system. For example, the call routing system may identify a call center with capacity for the call that is within the county identified by the county location code or closest to the county within the county location code. The call routing system may then route the call to the identified call center.

In this way, the embodiments disclosed herein serve to conserve network resources and thus increase network capacity by routing short code-based calls to the optimal call center based on a location of the UE (rather than the area code of the UE). The embodiments disclosed herein also protect the privacy of the caller by ensuring that the actual location of the caller is not provided to the external toll-free system and call routing system, and instead, only the county location code is provided to these systems. Therefore, in general, the embodiments disclosed herein also serve to increase network capacity by routing calls efficiently and effectively through the network, while also increasing the privacy provided to users of the services provided by the network.

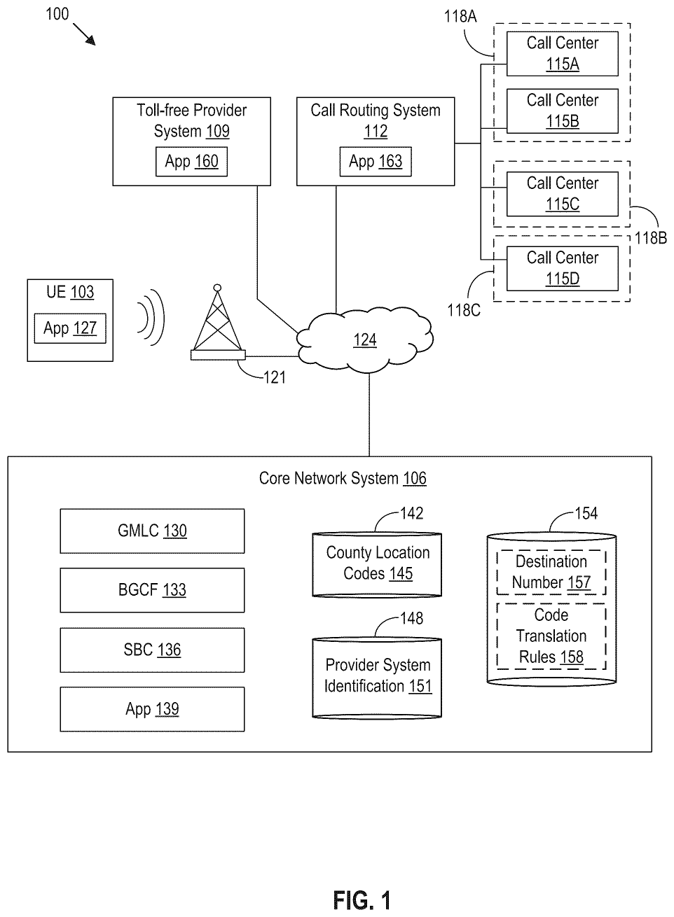

Turning now to FIG. 1, a communication network 100 is described. The communication network 100 includes a UE 103, a core network system 106, a toll-free provider system 109, a call routing system 112, one or more call centers 115A-D located in different geographic counties 118A-C, a cell site 121, and a network 124. The cell site 121 may provide a wireless communication link to the UE 103 according to a 5G, a long term evolution (LTE), a code division multiple access (CDMA), or a global system for mobile communications (GSM) wireless telecommunication protocol. The network 124 may be one or more private networks, one or more public networks, or a combination thereof. While FIG. 1 illustrates the network 124 as being separate from the core network system 106, toll-free provider system 109, and the call routing system 112, it should be appreciated that in some embodiments, the core network system 106, toll-free provider system 109, and/or the call routing system 112 may be part of the network 124.

The UE 103 may be a device used by an end-user to communicate with a network 124 and core network system 106, encompassing all hardware and software needed for connectivity. Examples of UEs 103 include, for example, cellular phones, smartphones, tablets, laptops, headset computers, wearable computers, Internet of Things (IoT) devices, and connected cars. The UE 103 may include an application 127, which may be instructions stored on a memory of the UE 103. The application 127 may be executed by a processor of the UE 103 to perform various operations as disclosed herein. For example, the application 127 may run a native dialer to dial 800 numbers or short codes to use and access resources provided by the core network system 106 (e.g., which may connect the UE 103 to the call centers 115A-D).

The user of the UE 103 may be a subscriber of a telecommunications service providing company. The telecommunications service providing company may provide cellular services (e.g., voice calls, messaging, file transfers, internet connectivity, location tracking, and other services) through the core network system 106 and the cell site 121. The core network system 106 may include the elements that manage the subscriber information, call setup and routing, and related system supports. In an embodiment, the core network system 106 may be an evolved packet core (EPC) core network and the RAN, which includes the cell site 121. The core network system 106 may be configured to implement a 5G, a LTE, a CDMA, Universal Mobile Telecommunications System (UMTS), or a GSM wireless telecommunication protocol. In one embodiment, the core network system 106 may be a 3rd Generation Partnership Project (3GPP) Evolved Packet System (EPS).

As shown in FIG. 1, the core network system 106 includes a Gateway Mobile Location Center (GMLC) 120, a Border Gateway Control Function (BGCF) 133, a Session Border Controller (SBC) 136, an application 139, and a location data store 142, a routing data store 148, and a translation data store 154. Each of the location data store 142, routing data store 148, and translation data store 154 may refer to a collection of data stored across one or more memories (co-located or distributed) in the core network system 106.

The location data store 142 may store the county location codes 145 for all of the different counties (and county equivalents) in the nation. As described above, the county location code 145 may be a unique predefined code assigned to each county in the nation. The county location code 145 may be a predefined number of digits representing a geographic region or area in the nation. For example, the county location code may be a five-digit code representing a county and embodied as a FIPs code. In an embodiment, the county location code 145 may be a code representing an imprecise location of a caller. In an embodiment, the county location code 145 may be a geohash (e.g., code) of the cell site 121 serving the UE 103, and the geohash may serve as the location proxy for the UE 103. A geohash may be a scalar number (e.g., code) that represents a rectangular geographic area. By appending more and more digits to the geohash of a location, the precision of a designation of the location increases. For example, if the cell site 121 has location with a geohash having 16-digits, summarily lopping off the last four digits may designate a larger (hence less precise) rectangular region that contains the cell site 121. In this way, a geohash of the cell site 121 truncated (e.g., reduced to a predetermined number of digits) to achieve a desirable indeterminateness of UE 103 location may be used as the county location code 145.

In an embodiment, the location data store 142 may store mappings between different types of location data identifying locations of UEs 103 and the corresponding county location code 145 for the location of the UEs 103. The different types of location data identifying the location of the UE 103 may include, for example, an actual location of the UE 103 (e.g., latitude and longitude coordinates of the UE 103 received by the core network system 106 from the UE 103), a location of the cell site 121 serving the UE 103 (e.g., latitude and longitude coordinates of the cell site 121 received/known by the core network system 106 from the cell site 121), an estimate of a location of the UE 103 (e.g., estimated latitude and longitude coordinates of the UE 103 obtained based on a mobile terminal-location request procedure performed between core network system 106 and the UE 103), a registered address associated with the UE 103 (e.g., potential latitude and longitude coordinates of the UE 103 based on an address indicated in a user account associated with the UE 103 and/or the user), etc.

The routing data store 148 may store provider system identifications 151 uniquely identifying toll-free provider systems 109, which are further described below. For example, the provider system identification 151 may include various types of data, such as, a toll-free number (e.g., a unique 1-800 toll-free number that may be dialed), a carrier identification code or service provider code (e.g., a code that identifies the toll-free service provider responsible for handling the call), routing information (e.g., details on how to route the call, including destination addresses, signaling information, and routing priorities), service type (e.g., information about the type of service associated with the toll-free provider system 109, which may influence routing and handling), routing rules (e.g., rules that specify different paths for routing the call), etc. In an embodiment, the routing data store 148 may store mappings between a call code (e.g., obtained based on a call received from the UE 103 and the county location code 145, as further described herein) and a corresponding provider system identification 151.

The translation data store 154 (also sometimes referred to as a “post route table”) may store destination numbers 157 and code translation rules 158. The translation data store 154 may be used in scenarios in which routing of the call may involve additional logic and more granular routing decisions based on various parameters. For example, the translation data store 154 may be used when the UE 103 uses a short code to call a service provided by the call centers 115A-D. The destination number 157 may refer to the complete destination toll-free number associated with the short code. The code translation rules 158 may include logic for transforming the call code to a routing code (e.g., removing certain digits from the call code while adding other digits to the call code and appending the destination number 157 to the call code to obtain the routing code).

The application 139 may operate as the CSCF or TAS in the core network system 106 to receive calls from the cell site 121, convert the calls to messages or SIP invites, and forward the messages to the appropriate entity in the core network system 106. The application 139 may also include the instructions corresponding to the execution of one or more of the GMLC 130, BGCF 133, and SBC 136, to perform the operations and steps described herein.

The GMLC 130 may use the location data store 142 to obtain a county location code 145 based on parameters of a call received from the UE 103. The parameters may include an identification of the UE 103 (e.g., the MSISDN or IMSI of the UE 103) and a location of the UE 103 (e.g., based on the aforementioned location types). The GMLC 130 may generate a call code based on the county location code 145, in which the call code comprises a predefined number (e.g., five) of steering digits (e.g., predefined or programmatically generated numeric digits) and the county location code 145. The GMLC 130 may then transmit a message (e.g., SIP invite) to the BGCF 133, in which the call code is carried in a header or a body of the message (e.g., SIP contact header).

The BGCF 133 may first use the routing data store 148 to determine a provider system identification 151 based on (at least a portion of) the call code received from the GMLC 130. For example, the BGCF 133 may perform a lookup in the routing data store 148 based on the call code to obtain the corresponding provider system identification 151.

The BGCF 133 may also use the translation data store 154 to determine a destination number 157 based on (at least a portion of) the call code and, in some embodiments, further based on the provider system identification 151 identified based on the call code. The BGCF 133 may also use the translation data store 154 to obtain code translation rules 158 associated with at least one of the call code, provider system identification 151, and/or the destination number 157. The BGCF 133 may then use the code translation rules 158 to transform the call code into the routing code, as further described herein. The BGCF 133 may then transmit a message (e.g., SIP invite) to the SBC 136, in which the routing code is carried in a header (or body) of the message.

The SBC 136 may modify the routing code according to a routing rule (e.g., instructions to remove and/or add digits, separate digits, etc.) programmed at the SBC 136 or stored in the core network system 106. For example, the SBC 136 may remove two of the leading predefined digits from the routing code to obtain a routing number (including a single leading predefined digit (indicating a carrier identifier) and the county location code 145), and the SBC 136 may extract the destination number 157 from the routing code. The SBC 136 may then generate a message (e.g., SIP invite) including the routing number and the destination number 157. In an embodiment, the destination number 157 may be carried in a RURI header field of the message. In an embodiment, the routing number (including the county location code) may be appended to an existing field in a header/body of the message (e.g., from field or caller-identification field), or the routing number (including the county location code) may be added to a new field in the header/body of the message. The SBC 136 may then transmit the message to the toll-free provider system 109 associated with the provider service identification 151 identified by the BGCF 133.

The toll-free provider system 109 may be a computer system, server software/hardware, or a collection of processors, memories, and/or networking resources used as a telecommunication service setup that enables enterprises to offer toll-free numbers, allowing customers to call the corresponding toll-free number without incurring charges. The toll-free provider system 109 comprises both hardware and software components, including call servers, database servers, signaling gateways, and routing platforms. The toll-free provider system 109 includes an application 160, which may be instructions stored on a memory of the toll-free provider system 109. The application 160 works with the hardware components to manage, route, and process incoming toll-free calls. The toll-free provider system 109 interfaces with a Public Telephone Network System (PTNS) to connect calls from UEs 103 to the toll-free provider system 109/call routing system 112, leveraging technologies such as Signaling System No. 7 (SS7) or SIP for signaling and routing. The toll-free provider system 109 routes the message received from the SBC 136 (e.g., SIP invite corresponding to the call) through the PTNS to a call routing system 112.

The call routing system 112 may be a computer system, server software/hardware, or a collection of processors, memories, and/or networking resources used as a call routing platform, to manage and direct incoming calls. The call routing system 112 comprises both hardware and software components, including call servers, database servers, signaling gateways, and routing platforms. The call routing system 112 includes an application 163, which may be instructions stored on a memory of the call routing system 112. The application 163 may determine the optimal call center 115A-D based on the county location code 145 included in the routing number carried in the message received from the toll-free provider system 109 and various other factors (e.g., capacity at the call center 115A-D, expertise of the counselors at the call center 115A-D, location of the call center 115A-D). The application 163 may then route the message (e.g., the call) to the identified optimal call center 115A-D to ultimately connect the UE 103 to the identified optimal call center 115A-D.

Each call center 115A-D may be located in a respective county 118A-C. There may be one or more call centers 115A-D in a single county 118A-C. As shown in FIG. 1, the county 118A includes call center 115A and 115B, county 118B includes call center 115C, and county 118C includes call center 115D. Each call center 115A-D may be a specialized facility staffed by trained personnel who may provide services to the callers operating the UEs 103. For example, the personnel may be counselors who provide immediate support, intervention, and resources to individuals in mental health crises, emotional distress, or suicidal situations.

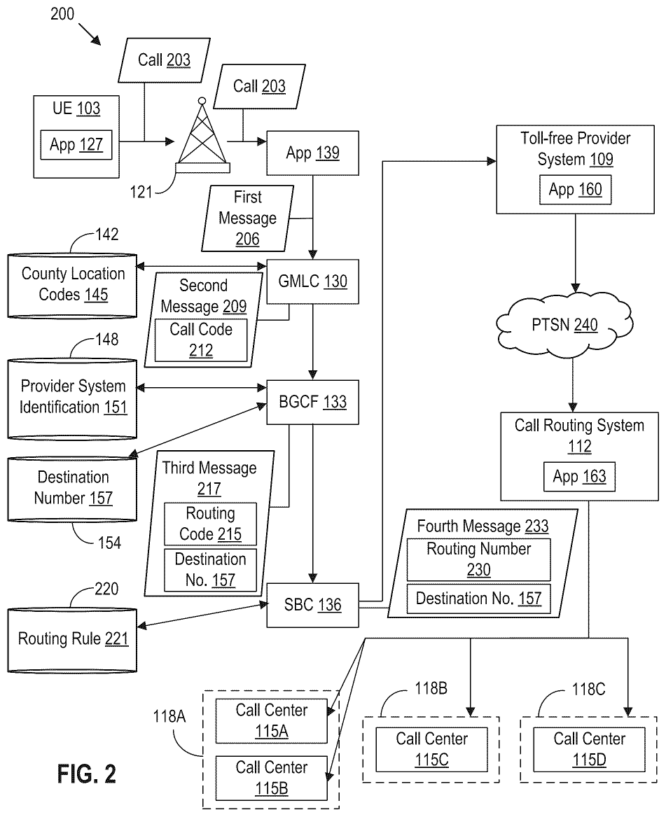

Referring now to FIG. 2, shown is a diagram illustrating a method 200 for county-based call routing in the communication network 100 of FIG. 1 according to various embodiments of the disclosure. Method 200 may begin when the user operating the UE 103 uses an application 127 to dial a number (e.g., short code for an 800 number or the full 800 number) corresponding to a service offered by a call center 115A-D. By dialing the number, the UE 103 transmits a call 203 to the cell site 121 (e.g., the nearest cell site 121) associated with the core network system 106. The call 203 may include an identification of the UE 103 (e.g., the MSISDN and/or IMSI of the UE 103), a dialed number/short code, and in some cases, a location of the UE 103/cell site 121). The call 203 may be transmitted to the cell site 121 as radio signals. The cell site 121 may then forward the call 203 to the core network system 106 over the backhaul network (e.g., network 124 and the core network system 106) using one or more different transportation technologies. In particular, the cell site 121 may forward the call to the application 139 at the core network system 106.

The application 139 (e.g., operating as the CSCF or TAS of the core network system 106) may generate a first message 206 (e.g., in the form of a SIP invite message) based on the data received with the call 203 (e.g., the MSISDN and/or IMSI of the UE 103, dialed number/short code, and/or a location of the UE 103/cell site 121). The first message 206 may include the data received with the call 203. The application 139 may route the first message 206 to the GMLC 130.

The GMLC 130 may access the location data store 142 to identify a county location code 145 based on the location of the UE 103/cell site 121. For example, the GMLC 130 may perform a lookup at the location data store 142 using the location of the UE 103 (which may be the actual location of the UE 103, the location of the cell site 121 serving the UE 103, an inferred location of the UE 103, etc.) to obtain the corresponding county location code 145. The GMLC 130 may then generate a call code 212 based on the identified county location code 145.

The call code 212 may be a series of numeric digits that include multiple steering digits (e.g., predefined or placeholder digits, which may correspond to a full 800 number) the county location code 145. For example, the call code 212 may include the following digits: 99801 (e.g., the steering digits) and the county location code 145. For example, suppose the county location code 145 corresponding to the location to the UE is 48113, then the call code 212 may be 9980148113. In an embodiment, the steering digits may correspond to a full 11-digit 800 digit phone number. For example, the 99801 steering digits may be specifically associated with the 800 phone number corresponding to the 988 short code, and thus the National Suicide Prevention Lifeline service. The GMLC 130 may generate a second message 209 (e.g., in the form of a SIP invite) including the call code 212 and/or at least a portion of the data obtained in the call 203 (e.g., the MSISDN and/or IMSI of the UE 103, dialed number/short code, and/or the identified location of the UE 103/cell site 121). For example, the application 139 may prepend the call code with a +1, and then add the prepended call code to the RURI header field of the second message 209 or to the SIP contact header of the second message 209. The GMLC 130 may transmit the second message 209 to the BGCF 133.

The BGCF 133 may receive the second message 209 and access the routing data store 148 and the translation data store 154 to generate a routing code 215. The routing code 215 may be a series of numeric digits including predefined digits, the county location code 145, and a destination number 157 (e.g., corresponding to the dialed number in the call 203).

In an embodiment, the BGCF 133 may first use the routing data store 148 to determine a provider system identification 151 of a toll-free provider system 109 based on (at least a portion of) the call code 212 and/or data from the call 203 received from the GMLC 130. For example, the BGCF 133 may perform a lookup in the routing data store 148 based on the call code 212 to obtain the corresponding provider system identification 151.

The BGCF 133 may also use the translation data store 154 to determine the destination number 157 based on (at least a portion of) the call code 212 and, in some embodiments, further based on the provider system identification 151. The BGCF 133 may also use the translation data store 154 to obtain code translation rules 158 associated with at least one of the call code 212, provider system identification 151, and/or the destination number 157. As mentioned above, the code translation rules 158 may include logic or instructions for the BGCF 133 to translate the call code 212 into the routing code 215 by removing the steering digits from the call code 212, adding predefined digits before the county location code 145, and appending the destination number 157 to the county location code 145. The BGCF 133 may then perform the logic prescribed in the code translation rules 158 to translate the call code 212 into the routing code 215.

For example, suppose the call code 212 is 9980148113, in which the digits 99801 constitute the steering digits and the digits 48113 constitute the county location code 145. Further, suppose the code translation rules 158 instruct the BGCF 133 to remove the steering digits from the call code 212, prepend the call code 212 with predefined digits (e.g., 111) and then append the call code 212 with the destination number 157 (e.g., 1800XXXXXXX) to obtain the routing code 215 (e.g., 111481131800XXXXXXX). The BGCF 133 may then generate and transmit a third message 217 (e.g., SIP invite) to the SBC 136, in which the routing code 215 is carried in a header or body of the third message 217. For example, the routing code 215 may be added to the RURI header field of the third message 217, and then sent to the SBC 136.

The SBC 136 may modify the routing code 215 according to a routing rule 221 (e.g., instructions to remove and/or add digits, separate digits, etc.) programmed at the SBC 136 or stored in a data store 220 of the core network system 106. For example, routing rule 221 may include logic instructing, based on one or more conditions, the SBC 136 to remove two of the leading predefined digits from the routing code 215 to obtain a routing number 230 (including a single leading predefined digit (indicating a carrier identifier identifying the telecommunications service provider associated with the core network system 106) and the county location code 145). Continuing with the example above, the routing code 215 may be 111481131800XXXXXXX, in which the digits 111 are the predefined prepended digits, 48113 is the county location code 145, and 1800XXXXXXX is the destination number 157. The SBC 136 may be programmed (e.g., using the routing rules 221) to modify the routing code 215 to remove the first two digits of the prepended digits and add a leading digit representing the carrier identification code (e.g., 1) to the county location code 145 to obtain a routing number 230. The SBC 136 may also be programmed (e.g., using the routing rules 221) to extract the destination number 157 from the routing code 215 received from the BGCF 133.

The SBC 136 may then generate a fourth message 233 (e.g., SIP invite) including the routing number 230 and the destination number 157. In an embodiment, the destination number 157 may be carried in a RURI header field of the message. In an embodiment, the routing number 230 (including the county location code 145) may be appended to an existing field in a header (or body) of the fourth message 233 (e.g., from field or caller-identification field), or the routing number 230 (including the county location code 145) may be added to a new field in the header (or body) of the fourth message 233. The SBC 136 may then transmit the fourth message 233 to the toll-free provider system 109 associated with the provider service identification 151 identified by the BGCF 133.

The application 160 of the toll-free provider system 109 may route the fourth message 233 and thus the call 203 through the PTSN 240 to the call routing system 112 based on, for example, the destination number 157 indicated in the fourth message 233. The application 163 of the call routing system 112 may then determine an optimal call center 115A-D using the fourth message 233 based on the county 118A-C identified in the routing number 230 (e.g., by removing the leading digit identifying the carrier) and various other factors (e.g., the capacity of the call centers 115A-D, the location of the call centers 115A-D relative to the identified county 118A-C, etc.). The application 163 may then route the fourth message 233 and thus the call 203 to the optimal call center 115A-D, which ultimately connects the UE 103 to the optimal call center 115A-D.

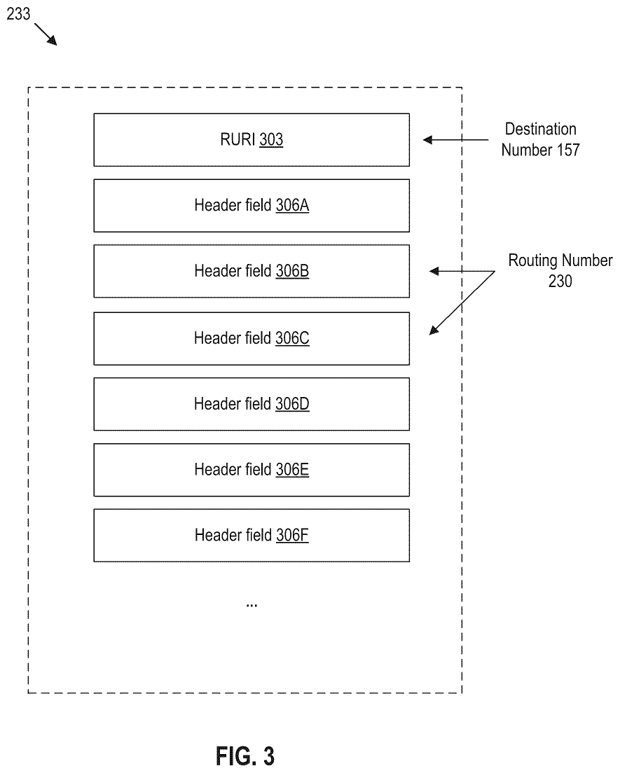

Referring now to FIG. 3, shown is a block diagram illustrating the fourth message 233 according to various embodiments of the disclosure. In an embodiment, the fourth message 233 may be encoded as a SIP invite and may include a header (e.g., a P-Asserted-Identity (PAI) header). The fourth message 233 may include a request line, which may include a RURI field 303, which may be used to carry the address of the device being invited to the session. A header of the fourth message 233 may include N number of header fields 306A-N (dependent on the information carried in the fourth message 233). For example, header field 306A may be a “To:” field to indicate the intended recipient of the fourth message 233, header field 306B may be a “From:” field to indicate the originator of the fourth message 233, header field 306C may be a “Call-ID:” field to indicate a unique identifier of the fourth message 233/call 203, header field 306D may be a “CSeq:” field to indicate a sequence number used to order requests within the transaction, header field 306E may be a “Via:” field to indicate a transport path for the fourth message 233, including the protocol and address of each hop, and header field 306F may be a “Contact:” field to indicate the URI at which the UE 103 can receive additional SIP requests.

The fourth message 233 may include additional fields (e.g., in the body) not shown in FIG. 3, and similarly, the header of the fourth message 233 may include additional optional header fields not shown in FIG. 3. For example, the header of the fourth message 233 may include a field to indicate a limit of a number of hops the fourth message 233 may transit on the way to the destination, a field to provide information about the software used by the UE 103, a list of protocols supported by the UE 103, a field to indicate the media type of the message body, a field to indicate a length of the message body, etc.

As discussed above with reference to FIG. 2, the fourth message 233 may include the destination number 157 in the RURI header field 303. The fourth message 233 may include the routing number 230, which may include a first digit that may identify a carrier and the county location code 145. The routing number 230 may be added to an existing header field 306A-F of the fourth message 233. For example, the routing number 230 may be added (e.g., prepended to the beginning of a value carried in the field or amended to the end of the value) to the header field 306B (“From:” field) or the header field 306C (“Call-ID” field). Alternatively, the routing number 230 may be added to a new dedicated header field in the fourth message 233. It should be appreciated that the routing number 230 may be carried anywhere within the fourth message 233, which is forwarded to the toll-free provider system 109 and call routing system 112, and ultimately used to connect the UE 103 to the optimal call center 115A-D.

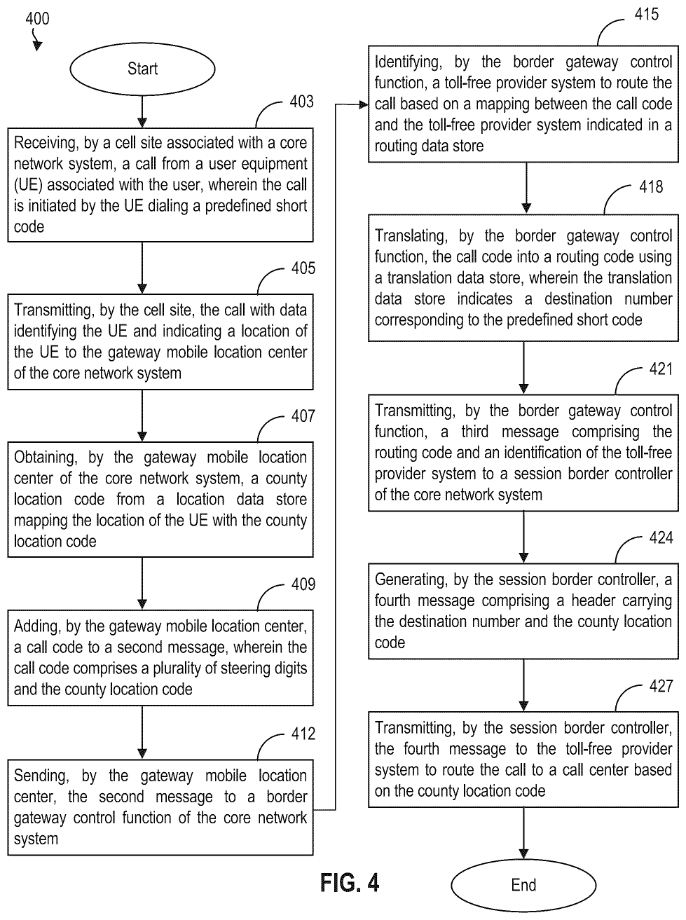

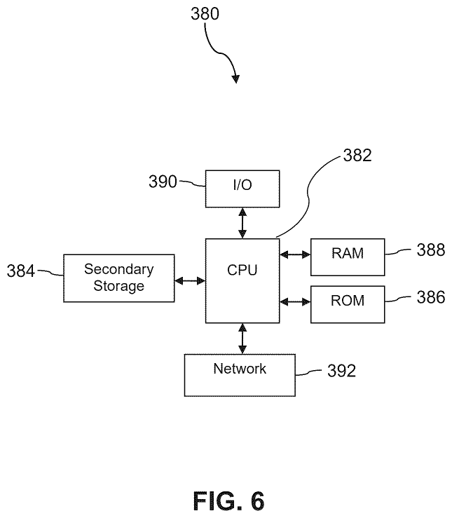

Referring now to FIG. 4, shown is a method 400 for county-based call routing in the communication network 100 of FIG. 1 according to various embodiments of the disclosure. Method 400 may be implemented by the UE 103, GMLC 130, BGCF 133, SBC 136, and application 139 of the core network system 106, toll-free provider system 109, call routing system 112, and call centers 115A-D. In embodiments, the method 400 may be implemented using a computer system with components as shown in FIG. 6. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At step 403, method 400 may comprise receiving, by a cell site 121 associated with a core network system 106, a call 203 from a UE 103 associated with a user. The call 203 is initiated when the UE 103 dials a predefined short code. At step 405, method 400 may comprise transmitting, by the cell site 121, the call 203 with data identifying the UE 103 and indicating a location of the UE 103 to the GMLC 130 of the core network system 106. At step 407, method 400 may comprise obtaining, by the GMLC 130 of the core network system 106, a county location code 145 from a location data store 142 mapping the location of the UE 103 with the county location code 145. At step 409, method 400 may comprise adding, by the GMLC 130, a call code 212 to a second message 209. The call code 212 comprises steering digits and the county location code 145. At step 412, method 400 may comprise sending, by the GMLC 130, the second message 209 to a BGCF 133 of the core network system 106.

At step 415, method 400 may comprise identifying, by the BGCF 133, a toll-free provider system 109 to route the call 203 based on a mapping between the call code 212 and the toll-free provider system 109 indicated in a routing data store 148. At step 418, method 400 may comprise translating, by the BGCF 133, the call code 212 into a routing code 215 using a translation data store 154. The translation data store 154 indicates a destination number 157 corresponding to the predefined short code. At step 421, method 400 may comprise transmitting, by the BGCF 133, a third message 217 comprising the routing code 215 and an identification of the toll-free provider system 109 (e.g., provider system identification 151) to an SBC 136 of the core network system 106.

At step 424, method 400 may comprise generating, by the SBC 136, a fourth message 233 comprising a header carrying the destination number 157 and the county location code 145 (e.g., the county location code 145 by itself or the routing number 230 (carrier identifier and county location code 145)). At step 427, method 400 may comprise transmitting, by the session border controller, the fourth message 233 to the toll-free provider system 109 to route the call 203 to a call center 115A-D based on the county location code 145 (e.g., or the routing number 230).

Method 400 may include other steps and/or features that are not otherwise shown in FIG. 4. In an embodiment, the location of the UE 103 is based on a location of the cell site 121 or latitude and longitude coordinates of the UE 103. In an embodiment, the county location code 145 is a predefined five-digit code corresponding to a county 118A-C associated with the location of the UE 103. In an embodiment, the steering digits comprise a five-digit code corresponding to the predefined short code, and the five-digit code comprises an ordered sequence of five numerical values. In an embodiment, the routing code 215 includes a plurality of predefined digits, the county location code 145, and the destination number 157.

In an embodiment, method 400 may further comprise obtaining, by the SBC 136 prior to generating the fourth message 233, a routing number 230 from the routing code 215 by removing at least two of the predefined digits from the routing code 215, in which the county location code 145 included in the fourth message 233 is the routing number 230. In an embodiment, the fourth message 233 is a SIP invite, and the destination number 157 is carried in a RURI field 303 of the SIP invite. In an embodiment, the county location code 145 or the routing number 230 is appended to an existing field (e.g., header field 306A-F) associated with UE 103 in the SIP invite.

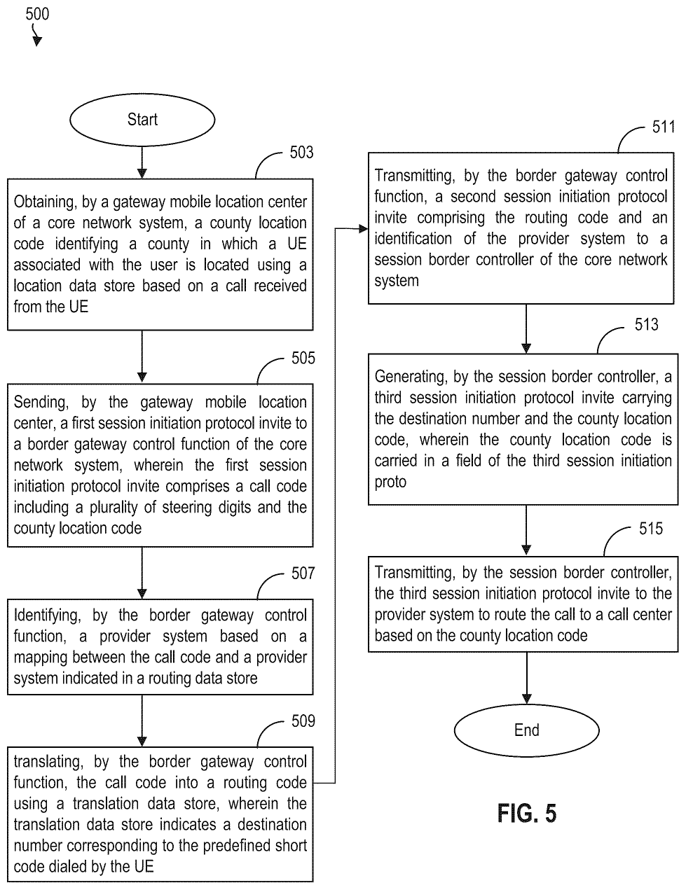

Referring now to FIG. 5, shown is a method 500 for county-based call routing in the communication network 100 of FIG. 1 according to various embodiments of the disclosure. Method 500 may be implemented by the UE 103, GMLC 130, BGCF 133, SBC 136, and application 139 of the core network system 106, toll-free provider system 109, call routing system 112, and call centers 115A-D. In embodiments, the method 500 may be implemented using a computer system with components as shown in FIG. 6. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 may comprise obtaining, by a GMLC 130 of a core network system 106, a county location code 145 identifying a county 118A-C in which a UE 103 associated with the user is located using a location data store 142 based on a call 203 received from the UE 103. At step 505, method 500 may comprise sending, by the GMLC 130, a first SIP invite (e.g., second message 209) to a BGCF 133 of the core network system 106. The first SIP invite comprises a call code 212 including a plurality of steering digits and the county location code 145.

At step 507, method 500 may comprise identifying, by the BGCF 133, a provider system 109 (e.g., the toll-free provider system 109) based on a mapping between the call code 212 and a provider system 109 indicated in a routing data store 148. At step 509, method 500 may comprise translating, by the BGCF 133, the call code 212 into a routing code 215 using a translation data store 154. The translation data store 154 indicates a destination number 157 corresponding to the predefined short code dialed by the user at the UE 103.

At step 511, method 500 may comprise transmitting, by the BGCF 133, a second SIP invite (e.g., third message 217) comprising the routing code 215 and an identification of the provider system 109 (e.g., the provider system identification 151) to an SBC 136 of the core network system 106. At step 513, method 500 may comprise generating, by the SBC 136, a third SIP invite (e.g., fourth message 233) carrying the destination number 157 and the county location code 145 (or the routing number 230). The county location code 145 (or the routing number 230) is carried in a field of the third SIP invite. At step 515, method 500 may comprise transmitting, by the SBC 136, the third SIP invite (e.g., fourth message 233) to the provider system 109 to route the call 203 to a call center based on the county location code 145 (or the routing number 230).

Method 500 may include other steps and/or features that are not otherwise shown in FIG. 5. In an embodiment, method 500 may further comprise identifying, by the GMLC 130, the county location code 145 based on a location of a cell site 121 serving the UE 103 and communicating with the core network system 106. In an embodiment, the county location code 145 is a predefined five-digit code corresponding to a county 118A-C associated with the location of the UE 103. In an embodiment, the steering digits comprise a five-digit code corresponding to the predefined short code, and the five-digit code comprises an ordered sequence of five numerical values. In an embodiment, the routing code 215 includes a plurality of predefined digits, the county location code 145, and the destination number 157. In an embodiment, the destination number 157 is carried in a RURI field 303 of the third SIP invite (e.g., fourth message 233).

FIG. 6 illustrates a computer system 380 suitable for implementing one or more embodiments disclosed herein. In an embodiment, the UE 103, GMLC 130, BGCF 133, SBC 136, application 139, systems 109 and 112, etc., may each be implemented as the computer system 380. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network to perform call routing to a call center based on a county associated with a location of a user, wherein the method comprises:
receiving, by a cell site associated with a core network system, a call from a user equipment (UE) associated with the user, wherein the call is initiated by the UE dialing a predefined short code;
transmitting, by the cell site, the call with data identifying the UE and indicating a location of the UE to a gateway mobile location center of the core network system;
obtaining, by the gateway mobile location center of the core network system, a county location code from a location data store mapping the location of the UE with the county location code;
adding, by the gateway mobile location center, a call code to a second message, wherein the call code comprises a plurality of steering digits and the county location code;
sending, by the gateway mobile location center, the second message to a border gateway control function of the core network system;
identifying, by the border gateway control function, a toll-free provider system to route the call based on a mapping between the call code and the toll-free provider system indicated in a routing data store;
translating, by the border gateway control function, the call code into a routing code using a translation data store, wherein the translation data store indicates a destination number corresponding to the predefined short code;
transmitting, by the border gateway control function, a third message comprising the routing code and an identification of the toll-free provider system to a session border controller of the core network system;
generating, by the session border controller, a fourth message comprising a header carrying the destination number and the county location code; and
transmitting, by the session border controller, the fourth message to the toll-free provider system to route the call to a call center based on the county location code.

2. The method of claim 1, wherein the location of the UE is based on a location of the cell site or latitude and longitude coordinates of the UE.

3. The method of claim 1, wherein the county location code is a predefined five-digit code corresponding to a county associated with the location of the UE.

4. The method of claim 1, wherein the steering digits comprise a five-digit code corresponding to the predefined short code, and wherein the five-digit code comprises an ordered sequence of five numerical values.

5. The method of claim 1, wherein the routing code includes a plurality of predefined digits, the county location code, and the destination number.

6. The method of claim 5, further comprising obtaining, by the session border controller prior to generating the fourth message, a routing number from the routing code by removing at least two of the predefined digits from the routing code, wherein the county location code included in the fourth message is the routing number.

7. The method of claim 1, wherein the fourth message is a Session Initiation Protocol (SIP) invite, wherein the destination number is carried in a requested uniform resource identifier field of the SIP invite.

8. The method of claim 7, wherein the county location code is appended to an existing field associated with UE in the SIP invite.

9. A method implemented in a communication network to perform call routing to a call center based on a county associated with a location of a user, wherein the method comprises:
obtaining, by a gateway mobile location center of a core network system, a county location code identifying a county in which a UE associated with the user is located using a location data store based on a call received from the UE;
sending, by the gateway mobile location center, a first session initiation protocol invite to a border gateway control function of the core network system, wherein the first session initiation protocol invite comprises a call code including a plurality of steering digits and the county location code;
identifying, by the border gateway control function, a provider system based on a mapping between the call code and a provider system indicated in a routing data store;
translating, by the border gateway control function, the call code into a routing code using a translation data store, wherein the translation data store indicates a destination number corresponding to a predefined short code dialed by the UE;
transmitting, by the border gateway control function, a second session initiation protocol invite comprising the routing code and an identification of the provider system to a session border controller of the core network system;
generating, by the session border controller, a third session initiation protocol invite carrying the destination number and the county location code, wherein the county location code is carried in a field of the third session initiation protocol; and
transmitting, by the session border controller, the third session initiation protocol invite to the provider system to route the call to a call center based on the county location code.

10. The method of claim 9, further comprising identifying, by the gateway mobile location center, the county location code based on a location of a cell site serving the UE and communicating with the core network system.

11. The method of claim 9, wherein the county location code is a predefined five-digit code corresponding to a county associated with the location of the UE.

12. The method of claim 9, wherein the steering digits comprise a five-digit code corresponding to the predefined short code, and wherein the five-digit code comprises an ordered sequence of five numerical values.

13. The method of claim 9, wherein the routing code includes a plurality of predefined digits, the county location code, and the destination number.

14. The method of claim 9, wherein the destination number is carried in a requested uniform resource identifier field of the third session initiation protocol invite.

15. A core network system, comprising:
at least one processor;
at least one memory coupled to the processor;
a gateway mobile location center, stored in the at least one memory, which when executed by the at least one processor, causes the gateway mobile location center to obtain a county location code identifying a county in which a user equipment (UE) associated with a user is located using a location data store based on a call received from the UE;
a border gateway control function, stored in the at least one memory, which when executed by the at least one processer, causes the border gateway control function to translate a call code received from the gateway mobile location center into a routing code using a translation data store, wherein the translation data store indicates a destination number corresponding to a predefined short code associated with at least one of the call code or the routing code; and
a session border controller, stored in the at least one memory, which when executed by the at least one processer, causes the session border controller to transmit, to a provider system, a message carrying the destination number and the county location code, wherein the county location code is carried in a caller identification field of the message.

16. The core network system of claim 15, wherein the message is a session initiation protocol invite, and wherein the provider system is identified based on the call code indicated in a routing data store accessible to the border gateway control function.

17. The core network system of claim 15, wherein the county location code is a predefined five-digit code corresponding to a county associated with the location of the UE.

18. The core network system of claim 15, wherein the call code comprises a plurality of steering digits and the county location code, wherein the steering digits comprise a five-digit code corresponding to the predefined short code, and wherein the five-digit code comprises an ordered sequence of five numerical values.

19. The core network system of claim 15, wherein the routing code includes a plurality of predefined digits, the county location code, and the destination number.

20. The core network system of claim 19, wherein the session border controller is further configured to modify the routing code by removing at least two of the predefined digits from the routing code to obtain a routing number, wherein the county location code included in the message is the routing number.
